(19) United States
(12) Patent Application Publication
(10) Pub. No.: US 2004/0184455 A1
(43) Pub. Date: Sep. 23, 2004

(54) System and method used by a gateway for processing fragmented IP packets from a private network

(75) Inventor: Jyun-Naih Lin, Taipei (TW)

Correspondence Address: BACON & THOMAS, PLLC, 625 SLATERS LANE, FOURTH FLOOR, ALEXANDRIA, VA, 22314

(73) Assignee: Institute for Information Industry, Taipei (TW)

(21) Appl. No.: 10/390,623

(22) Filed: Mar. 19, 2003

(51) Int. Cl. H04L 12/28

(52) U.S. Cl. 370/392; 370/401

(57) ABSTRACT

System and method used by a gateway for processing fragmented IP packets from a private network are provided. When receiving a first fragmented IP packet of a set, the gateway records information related to the packet in a NAPT table, records the source IP address and the IP identification of the packet, and the index of the NAPT table item in a fragmentation table, and changes the IP identification of the packet as the index of the fragmentation table item corresponding to the packet. When receiving other fragmented packet, the gateway searches the fragmentation table for finding a corresponding fragmentation table item, thereby retrieving the corresponding NAPT item as indicated by NAPT table index, and translating the source IP address into a legal gateway IP address, and changes the IP identification of the packet as the index of the fragmentation table item corresponding to the packet.

### BACKGROUND OF THE INVENTION

1. Field of the Invention

The present invention relates to a gateway for processing fragmented Internet Protocol (IP) packets and, more particularly, to a system and a method used by a gateway for processing fragmented IP packets from a private network.

2. Description of Related Art

Conventionally, an IP fragmentation must be performed on a packet having a length larger than a maximum transmission unit (MTU) before the packet is sent to a specific interface via the IP layer. For example, as shown in FIG. 1A, a large packet is fragmented into three fragmentation IP packets after the IP fragmentation is performed. Furthermore, as shown in FIG. 1B, each of the IP packets has the same identification (ID) and source IP address. This means that all three IP packets are formed from the same packet by means of IP fragmentation. Value ‘1’ in a more fragments (MF) bit of the ‘flag’ field means that there are subsequent IP packets originated from the same packet that has been fragmented by means of the same IP fragmentation. On the contrary, value ‘0’ in the MF bit of the ‘flag’ field means that there is no subsequent IP packet originated from the same packet which has been fragmented by means of the same IP fragmentation. Value in a field of fragment offset represents an offset of an IP packet within a packet that has not been fragmented by means of IP fragmentation. As shown, a first IP packet's value is 0 in the field of fragment offset. Hence, a machine at a destination is able to reassemble the received IP packets.

The available number of IP addresses is not sufficient as more and more machines are connected to the Internet. To eliminate this problem, a Network Address and Port Translation (NAPT) gateway is typically arranged between a private network and the Internet for address translation. For allowing a plurality of machines in the private network to share a legal IP address, a NAPT gateway is used as an intermediate point for sending IP packets. However, the well-known NAPT gateway suffers from several disadvantages. For example, the NAPT gateway may not correctly process fragmented IP packets from a private network. Moreover, a confusion may arise if two fragmented IP packets having the same ID and destination address are sent out from two different machines of a private network at the same time. This is best illustrated in FIG. 2. A first machine 10 in the private network sends a set of three fragmented IP packets having the same ID and source address to the third machine 30 via a NAPT gateway 50. This means that the fragmented IP packets are formed from the same packet by means of IP fragmentation. The IP packets are then sent to a third machine 30 in the Internet. In response to receiving a first one of the IP packets, the NAPT gateway 50 may record source IP address, source port, destination IP address, and destination port of the IP packet, translated gateway IP address, and translated source port in a NAPT table as a NAPT item based on the NAPT rule. Also, the source IP address of the IP packet is translated into a gateway IP address. Further, source port is translated at the NAPT gateway 50 accordingly.

At the same time, a second machine 20 coupled to the private network also sends another set of three fragmented IP packets to the third machine 30 via the NAPT gateway 50. The values of the identification field of the set of three fragmented IP packets that are set by the second machine 20 happen to be the same as those of the set of three fragmented IP packets originated from the first machine 10. Then, translated IP header of the set of three fragmented IP packets originated from the second machine 20 is the same as that originated from the first machine 10. Hence, the third machine 30 is not able to distinguish the fragmented IP packets received from the first machine 10 and that received from the second machine 20. As a result, a correct reassembly of either set of fragmented IP packets is not possible. Also, the third machine 30 cannot make a correct response to either the first machine 10 or the second machine 20.

### SUMMARY OF THE INVENTION

An object of the present invention is to provide a system and a method used by a gateway for processing fragmented IP packets from a private network so as to mitigate and/or obviate the aforementioned problems.

In accordance with one aspect of the present invention, the method used by a gateway for processing fragmented Internet Protocol (IP) packets from a private network in accordance with the present invention includes the steps of: (A) in response to receiving a first fragmented IP packet of a set at the gateway, recording the source IP address, the source port, the destination IP address, and the destination port of the packet, the translated NAPT gateway IP address, and the translated source port in a NAPT table as a NAPT item based on a Network Address and Port Translation (NAPT) rule, and recording the source IP address and the IP identification of the packet, and an index of the NAPT table item in a fragmentation table as a fragmentation item; (B) changing the IP identification of the packet as an index of the fragmentation table item corresponding to the packet; (C) in response to receiving other fragmented IP packet formed by segmenting the same packet as the first fragmented IP packet at the gateway, searching the fragmentation table for finding a corresponding fragmentation item based on the IP identification and the source IP address of the packet, thereby retrieving the corresponding NAPT table item of the NAPT table as indicated by NAPT table index in the fragmentation table item, and translating the source IP address of the fragmented IP packet into a legal gateway IP address based on the recorded NAPT table item; and (D) changing the IP identification of the packet as an index of the fragmentation table item corresponding to the packet.

In accordance with another aspect of the present invention, the system used by a gateway for processing fragmented Internet Protocol (IP) packets from a private network in accordance with the present invention includes: a first machine located in the Internet; at least one second machine located in a private network and capable of transmitting a plurality of fragmented IP packets to the first machine; and a Network Address and Port Translation (NAPT) gateway as an interface between the private network and the Internet for translating and routing the fragmented IP packets from the second machine to the first machine. When receiving a first fragmented IP packet of a set, the gateway records the source IP address, the source port, the destination IP address, and the destination port of the packet, the translated NAPT gateway IP address, and the translated source port in a NAPT table as a NAPT item based on a NAPT rule, records the source IP address and the IP identification of the packet, and the index of the NAPT item in a fragmentation table as a fragmentation item, and changes the IP identification of the packet as an index of the fragmentation item corresponding to the packet. When receiving other fragmented IP packet formed by segmenting the same packet as the first fragmented IP packet, the gateway searches the fragmentation table for finding a corresponding fragmentation item based on the IP identification and the source IP address of the packet, thereby retrieving the corresponding NAPT item of the NAPT table as indicated by NAPT index in the fragmentation table item, translates the source IP address of the fragmented IP packet into the legal gateway IP address based on the NAPT item, and changes the IP identification of the packet as an index of the fragmentation table item corresponding to the packet.

Other objects, advantages, and novel features of the invention will become mote apparent from the detailed description when taken in conjunction with the accompanying drawings.

### BRIEF DESCRIPTION OF THE DRAWINGS

FIG. 1A is a schematic view illustrating a fragmentation of a packet into three fragmented IP packets;

FIG. 1B is a schematic view illustrating various fields of a fragmented IP packet shown in FIG 1A;

FIG. 2 presents schematically a transmission of fragmented IP packets from first and second machines to a third machine via a conventional NAPT gateway;

FIG. 3 is a flow chart for processing fragmented IP packets transmitted from a private network in accordance with the present invention;

FIG. 4 presents formats of the NAPT table and the fragmentation table; and

FIG. 5 presents schematically a transmission of fragmented IP packets from first and second machines to a third machine via a NAPT gateway in accordance with the present invention.

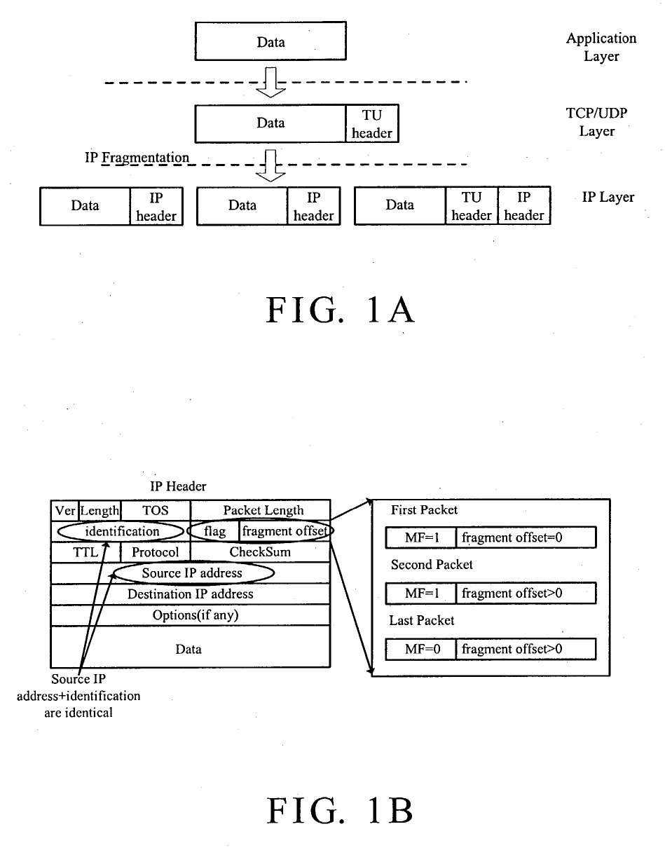

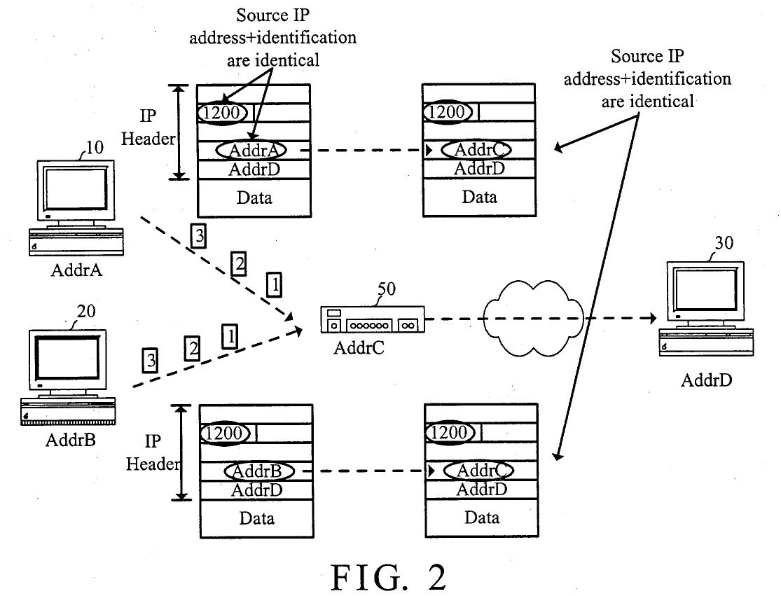

### DETAILED DESCRIPTION OF THE PREFERRED EMBODIMENT

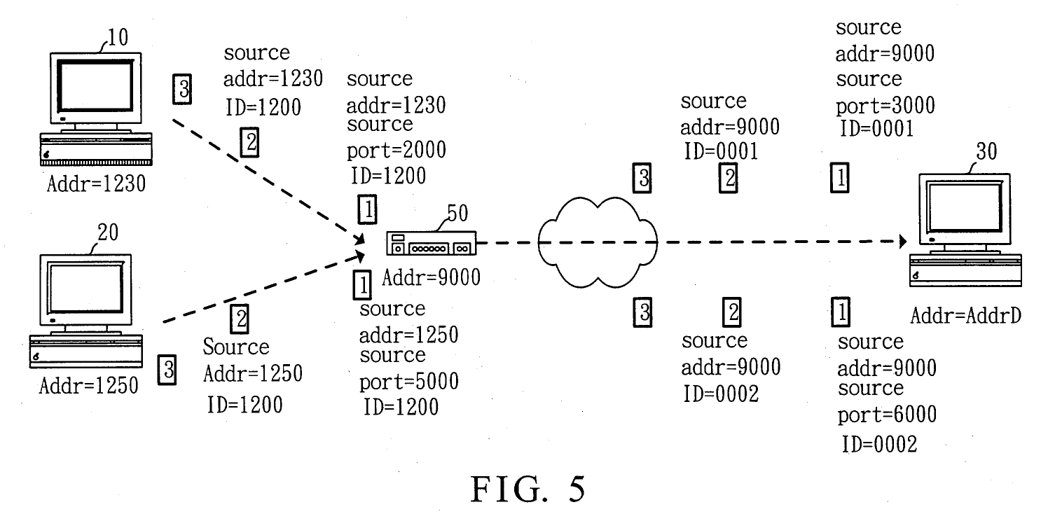

With reference to FIG. 5, the operation of the system used by a gateway for processing fragmented IP packets from a private network in accordance with the present invention is schematically illustrated. The system comprises a first machine 10, a second machine 20 both located in a private network, a NAPT gateway 50 as an interface between the private network and the Internet, and a third machine 30 in the Internet. Each of the first and second machines can perform an IP fragmentation on a packet for forming a set of a plurality of fragmented IP packets which are then sent to the third machine 30 via the NAPT gateway 50.

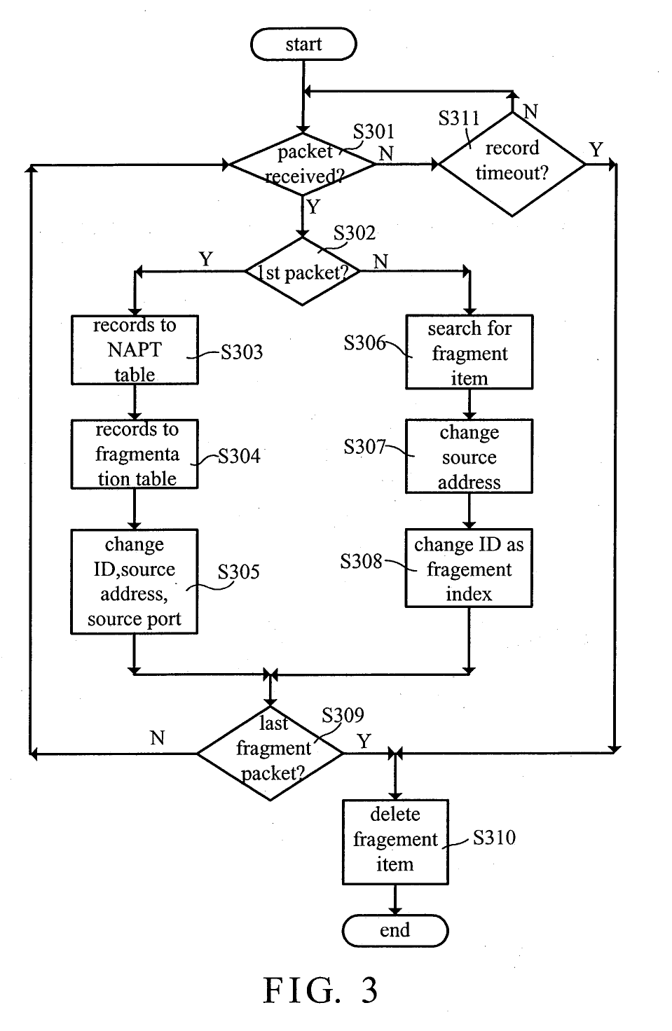

With reference to FIG. 3, there is shown a flow chart for processing the fragmented IP packets by the gateway 50. Steps of the process will now be described in detail below. In step S301, it is determined by the NAPT gateway 50 whether one of the fragmented IP packets is received. If yes, the process goes to step S302. Otherwise, the process jumps to step S311. In step S302, it is determined whether the received fragmented IP packet is the first one of a set of fragmented IP packets (i.e., the first fragmented IP packet of a set). If yes, the process goes to step S303. Otherwise, the process jumps to step S306. Note that if the value in the fragment offset field is 0 and the value in the MF bit of the flag field is 1, it indicates that the fragmented IP packet is the first one. On the contrary, if the value in the fragment offset field is not 0, it indicates that the fragmented IP packet is not the first one.

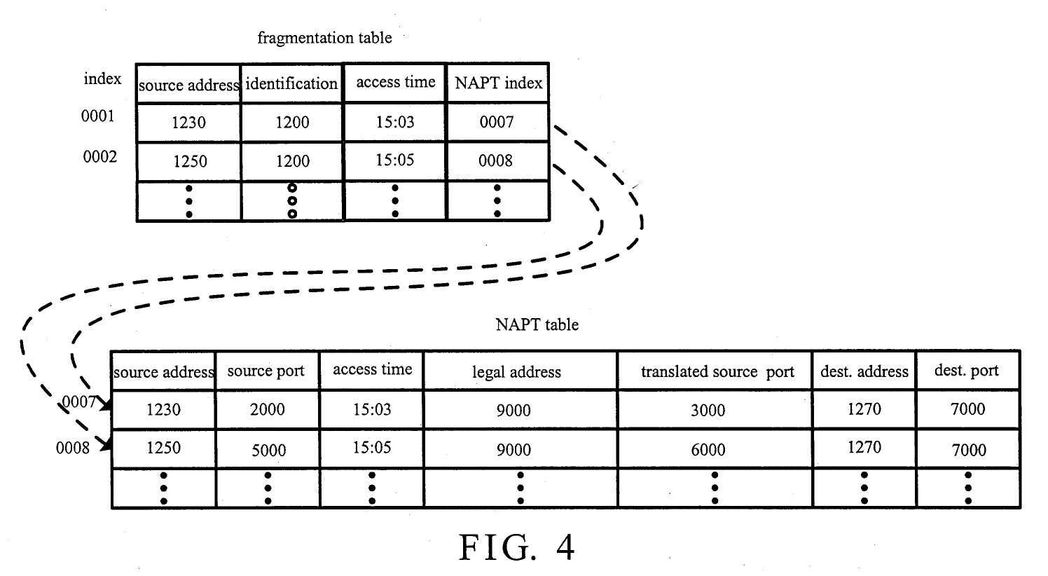

Following steps are illustrated as referred to FIG. 4. In step S303, the NAPT gateway 50 records source IP address, source port, destination IP address, destination port, access time of the IP packet, translated gateway IP address, and the translated source port in a NAPT table as a NAPT item based on the NAPT rule. In step S304, the source IP address, ID, access time of the IP packet, and NAPT table index are recorded in a fragmentation table as a fragmentation item.

In step S305, IP identification of the packet is changed as an index of the fragmentation table item corresponding to the packet(or a summation of index of the corresponding fragmentation item and a predetermined integer). The source IP address of the packet is changed as the translated gateway IP address. The source port of the packet is changed as the translated source port of the NAPT table item for the packet.

In step S306, it searches the fragmentation table for finding a corresponding fragmentation item based on the IP identification and source IP address of the packet. Once a fragmentation item is found, it is possible of retrieving the corresponding NAPT item in the NAPT table as indicated by NAPT table index that is recorded in the fragmentation table item. In step S307, the source IP address of the packet is translated into the gateway IP address based on the NAPT table item. In step S308, the IP identification of the packet is changed as a corresponding index of the fragmentation table item and a latest access time is written into the fragmentation table item and NAPT table item.

The process goes to step S309 if one of steps S305 and S308 has been performed. In step S309 it is determined whether a last fragmented IP packet of a set has been received by examining the MF bit of the flag field in IP header of the packet. If the value of the MF bit of the flag field of IP header is 0, it means that the fragmented IP packet is the last one (i.e., no subsequent fragmented IP packet of the set). If yes, the process goes to step S310. Otherwise, the process loops back to step S301. In step S310, all data about the received fragmented IP packets of the set recorded in the fragmentation table is deleted.

In step S311, it is determined whether there is no fragmented IP packet of a set received after a predetermined period of time has passed. If yes (i.e., there is error during the packet transmission), the process jumps to step S310. In step S310, the gateway 50 deletes the corresponding fragment table item of the set of fragmented IP packets. Otherwise, the process loops back to step S301.

With reference to FIG. 5 again, as described in the background of the invention, a problem may arise at the third machine if two fragmented IP packets having the same ID and destination address are sent out from two different machines in the private network at the same time when the conventional NAPT gateway is employed. Preferably, in the present invention, ID(1200) of the first machine 10 has been changed as 0001 and ID(1200) of the second machine 20 has been changed as 0002 respectively. As a result, there is no confusion with respect to either set of IP packets as received at the third machine 30.

Although the present invention has been explained in relation to its preferred embodiment, it is to be understood that many other possible modifications and variations can be made without departing from the spirit and scope of the invention as hereinafter claimed.

What is claimed is:

1. A method used by a gateway for processing fragmented Internet Protocol (IP) packets from a private network, comprising the steps of:
(A) in response to receiving a first fragmented IP packet of a set at the gateway, recording the source IP address, the source port, the destination IP address, and the destination port of the packet, a translated NAPT gateway IP address, and the translated source port in a NAPT table as a NAPT item based on a Network Address and Port Translation (NAPT) rule, and recording the source IP address and the IP identification of the packet, and an index of the NAPT table item in a fragmentation table as a fragmentation item;
(B) changing the IP identification of the packet as the index of the fragmentation table item corresponding to the packet;
(C) in response to receiving other fragmented IP packet formed by segmenting the same packet as the first fragmented IP packet at the gateway, searching the fragmentation table for finding a corresponding fragmentation item based on the IP identification and the source IP address of the packet, thereby retrieving the corresponding NAPT item of the NAPT table as indicated by NAPT table index in the fragmentation item, and translating the source IP address of the fragmented IP packet into the legal gateway IP address based on the NAPT table item; and
(D) changing the IP identification of the packet as the index of the fragmentation table item corresponding to the packet.

2. The method as claimed in claim 1, wherein step (A) further writes an access time for the packet into the NAPT item.

3. The method as claimed in claim 2, further comprising a step (E) of writing a latest access time into the NAPT item.

4. The method as claimed in claim 1, wherein in the step (D), the IP identification of the fragmented IP packet is changed as a summation of the index of the corresponding fragmentation table item and a predetermined integer.

5. The method as claimed in claim 1, further comprising a step (F) of recycling the fragmentation table item if none of the fragmented IP packets of a set is received after a predetermined period of time has passed or a last fragmented IP packet of a set has arrived at the gateway.

6. A system used by a gateway for processing fragmented Internet Protocol (IP) packets from a private network, comprising:
a first machine located in the Internet;
at least one second machine located in a private network and capable of transmitting a plurality of fragmented IP packets to the first machine; and
a Network Address and Port Translation (NAPT) gateway as an interface between the private network and the Internet for translating and routing the fragmented IP packets from the second machine to the first machine;
wherein, when receiving a first fragmented IP packet, the gateway records the source IP address, the source port, the destination IP address, and the destination port of the packet, the translated NAPT gateway IP address, and the translated source port in a NAPT table as a NAPT item based on a NAPT rule, records the source IP address and the IP identification of the packet, and the index of the NAPT table item in a fragmentation table as a fragmentation item, and changes the IP identification of the packet as the index of the fragmentation item corresponding to the packet; when receiving other fragmented IP packet formed by segmenting the same packet as the first fragmented IP packet, the gateway searches the fragmentation table for finding a corresponding fragmentation item based on the IP identification and the source IP address of the packet, thereby retrieving the corresponding NAPT item of the NAPT table as indicated by NAPT table index in the fragmentation table item, translates the source IP address of the fragmented IP packet into the legal gateway address based on the NAPT table item, and changes the IP identification of the packet as the index of the fragmentation table item corresponding to the packet.

7. The system as claimed in claim 6, wherein when receiving the first fragmented IP packet of a set, the gateway writes an access time of the first packet into the corresponding NAPT table item.

8. The system as claimed in claim 7, wherein when receiving other fragmented IP packet formed by segmenting the same packet as the first fragmented IP packet, the gateway writes a latest access time into the corresponding NAPT table item.

9. The system as claimed in claim 6, wherein when receiving other fragmented IP packet formed by segmenting the same packet as the first fragmented IP packet, the gateway changes the IP identification of the packet as a summation of the index of the corresponding fragmentation table item and a predetermined integer.

10. The system as claimed in claim 6, wherein if none of the fragmented IP packets of a set is received after a predetermined period of time has passed or a last fragmented IP packet of a set has arrived at the gateway, the corresponding fragmentation table item is recycled.
